(19) United States
(12) Patent Application Publication
(10) Pub. No.: US 2017/0115009 A1
(43) Pub. Date: Apr. 27, 2017

(54) FOOD TRUCK HAVING A LOW PROFILE EXHAUST SYSTEM

(71) Applicants: Nicholas A. Ramphos, Canton, OH (US); Anthony Ramphos, North Canton, OH (US)

(72) Inventors: Nicholas A. Ramphos, Canton, OH (US); Anthony Ramphos, North Canton, OH (US)

(21) Appl. No.: 15/335,102

(22) Filed: Oct. 26, 2016

Related U.S. Application Data
(60) Provisional application No. 62/246,891, filed on Oct. 27, 2015.

(51) Int. Cl. F24C 15/20; F24C 15/30; B60P 3/025; F04D 25/08; F04D 29/52

(52) U.S. Cl. CPC F24C 15/2042; F04D 25/08; F04D 29/522; B60P 3/0257; F24C 15/30

(57) ABSTRACT

A food truck having a low profile exhaust system is provided. The low profile exhaust system on the food truck extends through either the left sidewall, the right sidewall, or the rear sidewall of the food truck to remove exhaust gases from the kitchen area within the interior of the food truck. The exhaust system has a stack or chimney on the outside of the truck that extends upwardly a short distance terminating at a top end that is generally equal to that of the roof of the food truck such that the food truck is not limited by federal or state rules, regulations, or restrictions of commercial vehicles based on their heights.

### CROSS REFERENCE TO RELATED APPLICATIONS

This application claims priority to pending prior U.S. Provisional Patent Application Ser. No. 62/246,891, filed on Oct. 27, 2015; the disclosure of which is entirely incorporated herein by reference.

### BACKGROUND OF THE DISCLOSURE

Technical Field

The present disclosure relates generally to the food truck industry. More particularly, the present disclosure generally relates to a food truck having an exhaust system to ventilate a cooking area. Specifically, the present disclosure relates to an exhaust system on a food truck that extends through one of the vertically extending sidewalls or end wall of the food truck resulting in a low profile exhaust system having a vertical height lower than that of a conventional roof discharge exhaust system on a food truck.

Background Information

The food truck industry includes businesses that are primarily engaged in preparing and serving meals from a mobile truck. The food is normally stored, prepared, and cooked on the truck in a conventional cooking device such as a grill, deep fryer, or oven. These mobile food trucks may or may not be positioned at the same location each day.

Industry reports suggest that the remarkable rise of the food truck industry over recent years will continue to experience growth in the years to come. Namely, one report suggests that the annual growth of the food truck industry may be as high as nine percent per year with current estimated annual revenues around 900 million dollars and employing over 14,000 people across the United States. Further, reports suggest that the food truck industry has outperformed the broader brick and mortar food service sector over the same period of time in terms of revenue expansion.

This competition will continue to increase as large brands and existing chain restaurants recognize the growth in the food truck industry and thus launch food trucks of their own. Another study indicates that about twenty-six percent of fast food chain restaurants are interested in establishing food trucks of their own. Major brands such as Chick-Fil-A, Burger King, and TCBY have already added food trucks with a growing number of other brick and mortar fast food restaurants expected to do the same.

As the food truck industry grows, the demand for manufactured trucks will necessarily increase. The trucks used in the industry are large vehicles that define an interior cooking area or kitchen therein. As with any commercial cooking environment, proper ventilation is needed to remove cooking gases from the kitchen area for comfort and safety reasons.

For this reason, food trucks are outfitted with exhaust fans similar to those found in brick and mortar restaurants. These exhaust fans are large structures that include a fan powered by an electric motor moving air and drawing the cooking gases out from the kitchen area into the open environment outside the food truck.

These food trucks are large vehicles that must comply with both federal and state highway rules, regulations, and codes. Some states impose height restrictions on commercial vehicles for travelling on roadways. Some state regulations may have a preclusive effect on commercial vehicles that may be limited by height.

### SUMMARY

Issues continue to exists in the food truck industry based on the vertical height of the food truck once an exhaust fan and ventilation stack is attached thereto to vent gases from the cooking area. Namely, currently known food trucks may exceed certain rules and regulations for height and be precluded from traveling on some roads. Thus, a need continues to exist for a food truck vehicle that has an exhaust fan and vent stack that is of a sufficiently low profile so as to allow the food truck to continue to travel on all roads within the rules and regulations for commercial vehicles. The present disclosure addresses these and other issues.

In one aspect, an embodiment may provide a food truck comprising: a vertically extending left sidewall spaced from a vertically extending right sidewall; a rear endwall extending between the left and right sidewalls; a kitchen area interior to the food truck defined between the left and right sidewalls; and an exhaust system defining an exhaust passageway through one of (i) the left sidewall, (ii) the right sidewall, and (iii) the rear endwall. Further, the exhaust system may include a vent stack exterior to the truck extending upwardly and terminating at a height similar to that of a roof.

In another aspect, an embodiment may provide a food truck having a low profile exhaust system. The low profile exhaust system on the food truck extends through either the left sidewall, the right sidewall, or the rear sidewall of the food truck to remove exhaust gases from the kitchen area within the interior of the food truck. The exhaust system has a vent stack or chimney on the outside of the truck that extends upwardly a short distance terminating at a top end that is generally equal to that of the roof of the food truck such that the food truck is not limited by federal or state rules, regulations, or restrictions of commercial vehicles based on their heights.

In yet another aspect, an embodiment of the present disclosure may provide a food truck comprising: a left sidewall spaced from a right sidewall; a rear endwall extending between the left and right sidewalls; a roof; a kitchen area interior to the food truck defined between the left and right sidewalls and below the roof, and within the kitchen area is positioned at least one of the following cooking devices: a deep fryer, an oven, a stove, and a grill; and a low profile cooking exhaust system defining an exhaust passageway extending at a height generally not exceeding the roof through one of (i) the left sidewall, (ii) the right sidewall, and (iii) the rear endwall adapted to remove resultant cooking gases and fumes from the kitchen area produced by the cooking devices. This embodiment may further comprise an outlet of the exhaust passageway exterior to one of (i) the left sidewall, (ii) the right sidewall, and (iii) the rear endwall, and the outlet positioned at a height generally similar to that of the roof. In another embodiment, the outlet of the exhaust passageway is defined at a height flush with the roof. In another embodiment, the outlet of the exhaust passageway is defined at a height below the roof. In another embodiment, the outlet of the exhaust passageway is defined by an exterior assembly such that the outlet is positioned transversely offset from one of (i) the left sidewall, (ii) the right sidewall, and (iii) the rear endwall. In another embodiment, the outlet of the exhaust passageway is defined by an exterior assembly such that the outlet is positioned transversely offset from the roof. Another embodiment may include a perpendicular alignment of the exhaust passageway through the one of (i) the left sidewall, (ii) the right sidewall, and (iii) the rear endwall such that the resultant cooking gases and fumes move in a generally transverse direction inside the kitchen area and in a generally vertical direction exterior to the truck. Another embodiment may include a fan positioned along the exhaust passageway, wherein the a portion of fan is below the roof. Another embodiment may include a fan axis of rotation parallel to and below the roof. Another embodiment may include a fan axis of rotation substantially perpendicular to one of (i) the left sidewall, (ii) the right sidewall, and (iii) the rear endwall. Another embodiment may include a frame carrying the fan, wherein the frame positions the fan in an opening defined by one of (i) the left sidewall, (ii) the right sidewall, and (iii) the rear endwall, wherein the opening is along a portion of the exhaust passageway. Another embodiment may include a first vent stack exterior to the truck extending upwardly and terminating at a height similar to that of a roof. Another embodiment may include a second vent stack exterior to the truck extending upwardly and terminating at a height similar to that of a roof. Another embodiment may include, wherein the first and second vent stacks are positioned on the same side of the truck. Another embodiment may include a louvered shutter substantially exterior the one of (i) the left sidewall, (ii) the right sidewall, and (iii) the rear endwall and terminating at a height similar to that of the roof.

In yet another aspect, an embodiment of the present disclosure may provide a method comprising: providing a food truck having a low profile cooking exhaust system defining an exhaust passageway extending at a height generally not exceeding a roof through one of (i) a left sidewall, (ii) a right sidewall, and (iii) a rear endwall; preparing a food item with a cooking device inside a kitchen area in the food truck produced by a cooking device; and effecting air movement below the roof along the exhaust passageway through one of (i) the left sidewall, (ii) the right sidewall, and (iii) the rear endwall to remove resultant cooking gases and fumes from the kitchen area in the food truck produced by the cooking device.

In yet another aspect, an embodiment of the present disclosure may provide a food truck comprising: an engine operatively connected to ground-engaging wheels adapted to transport the food truck; a longitudinally and vertically extending left sidewall; a longitudinally and vertically extending right sidewall spaced offset from the left sidewall; a transversely and vertically extending rear endwall positioned between the left and right sidewalls; a roof topping the left and right sidewalls and the rear endwall; a floor extending between the left and right sidewalls; a kitchen interior to the left and right sidewalls, the rear endwall, and below the roof and above the floor; a cooking device supported by the floor and disposed in the kitchen requiring adequate ventilation during operation; a low profile exhaust system including: at least one vent stack exterior to one of one of (i) the left sidewall, (ii) the right sidewall, and (iii) the rear endwall; a fan rotatable about an axis parallel to the floor; an outlet to an exhaust passageway defined by the at least one vent stack, wherein the outlet is at a height proximate the roof.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of a food truck having an exhaust system maintaining a low vertical profile by extending through one of the sidewalls of the truck rather than extending outwardly through the roof;

FIG. 2 is a rear end elevation view of the food truck taken along line 2-2 in FIG. 1 depicting the exhaust system extending outwardly from the left sidewall and the top of the exhaust system being generally equal with the same vertical height as the roof;

FIG. 3 is a transverse cross section view taken along line 3-3 of FIG. 1 depicting the exhaust system extending through the left sidewall of the truck;

FIG. 4 is a longitudinal cross section view taken along line 4-4 of FIG. 2 depicting the interior of the food truck or the kitchen area;

FIG. 5 is a longitudinal cross section view taken along line 4-4 of FIG. 2 depicting an alternative embodiment of the food truck of the present disclosure having an exhaust system exiting out the rear wall of the food truck rather than one of the sidewalls;

FIG. 6 is a transverse cross section view taken along line 3-3 of FIG. 1 depicting an alternative exhaust system having an intake vent coupled thereto to create a greater exchange of air within the kitchen area;

FIG. 7 is a longitudinal cross section of the food truck depicting a rear exiting vent having gravity louvered shutters; and

FIG. 8 is a transverse cross section depicting an alternative embodiment having a low profile discharge vent exiting through the roof.

Similar numbers refer to similar parts throughout the drawings.

### DETAILED DESCRIPTION

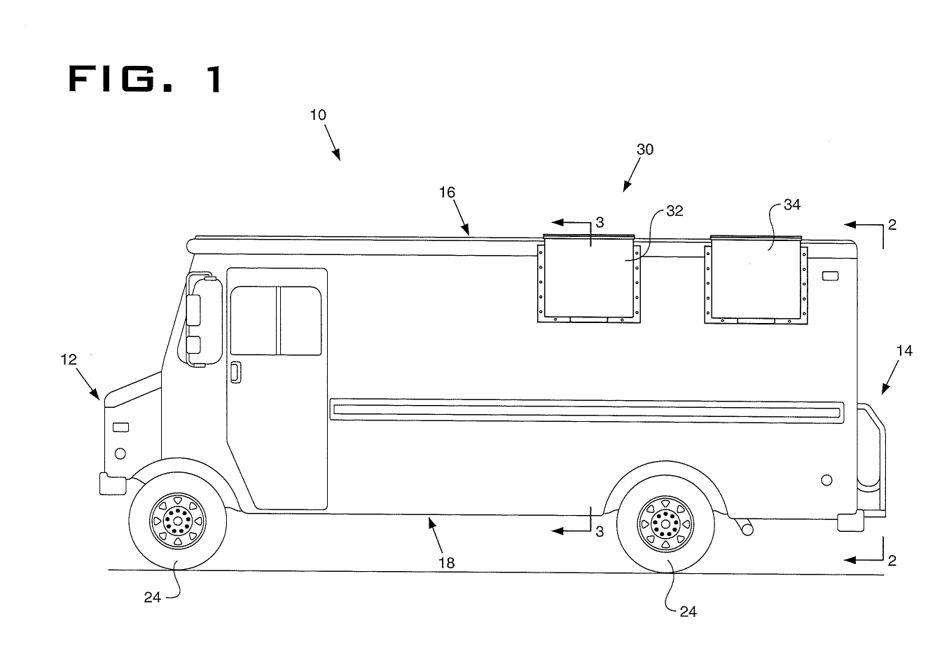

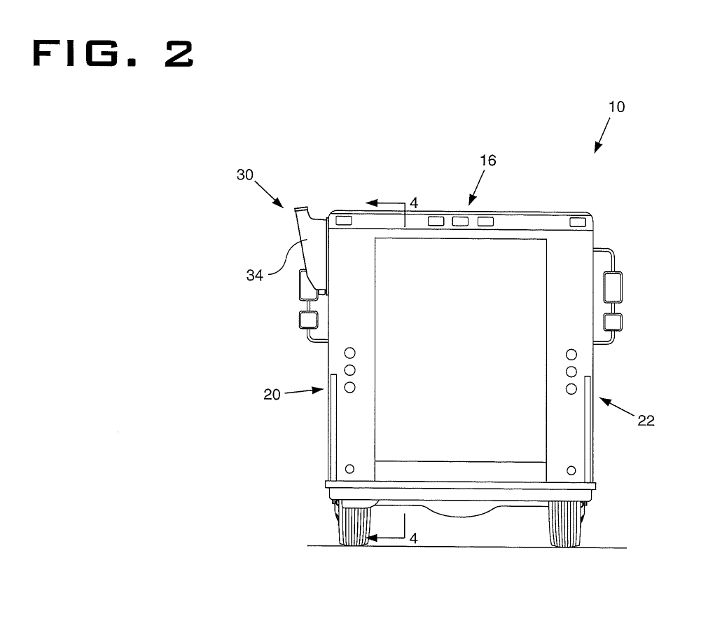

As depicted in FIG. 1 and FIG. 2, a food truck 10 includes a front end 12 spaced forwardly from a rear end 14 defining a longitudinal direction therebetween. A top panel or roof 16 is spaced above from a bottom 18 and defines a vertical direction therebetween. A left sidewall or panel 20 is spaced apart from a right sidewall or panel 22 defining a transverse direction therebetween. Truck 10 is supported by ground engaging wheels 24 that are operatively coupled to an engine configured to power truck 10 such that it is able to move from one location to another location.

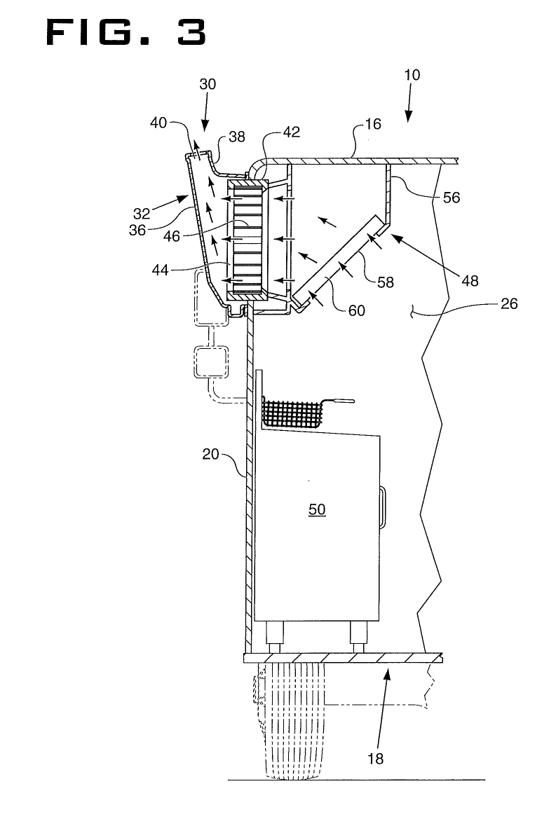

In one particular embodiment, the roof 16, the left panel 20, and the right panel 22 are generally rigid and planar members fixedly secured together in a conventional manner and define an interior kitchen space or area 26 (FIG. 3) therein. Some exemplary materials utilized to fabricate roof 16, left panel 20, and right panel 22 include aluminum, stainless steel, other sheet metals, or other generally rigid non-metal materials.

Inasmuch as food truck 10 is a large vehicle equipped to cook and sell food at various locations, an exhaust system 30 is provided to ventilate and remove various gases and odors produced in the kitchen area. Exhaust system 30 includes a first vent stack 32 and second vent stack 34. Furthermore, while not shown in the figures, it is understood that food truck 10 will have other well-known features, such as a service window through which food is passed or a generator to create electric power.

As depicted in FIG. 3, a transverse cross section detailing first vent stack 32 is provided. It is to be understood that the second vent stack 34 is operatively coupled to similar components such that the first vent stack 32 and the second vent stack 34 cooperate together to clear and vent the gases and odors emanating from the kitchen area 26 during the cooking process. First vent stack 32 includes an outer wall 36 that is positioned transversely offset and outwardly relative to left sidewall 20. In one embodiment, the first vent stack may be entirely outward relative to left sidewall 20. While first vent 32 is depicted herein as being offset to the left side of left sidewall 20, it is to be understood that it is entirely possible for a similarly constructed vent stack to be offset from the right side of truck 10. Outer wall 36 is slightly angled or inclined relative to the directly vertical left panel 20. In one particular embodiment, the angled relationship of outer wall 36 relative to vertical left sidewall 20 is in a range from about 5° to about 45°. More particularly, the angled relationship between outer wall 36 and left panel 20 may be in a range from about 10° to about 25°. First vent stack 32 further includes an L-shaped upper wall 38 having an upwardly extending short leg and a transversely extending long leg. An outlet 40 of an exhaust passageway or exhaust path is defined between outer wall 36 and upper wall 38. Vent stack 32 mounts to truck 10 via a frame 42 transversely aligned and defining a through passage or passageway 44. The passageway 44 extends transversely from left to right through panel 20. Additionally, passageway 44 is entirely below roof 16. Moreover, the exhaust passageway may be positioned above the cooking components installed in the kitchen area 26.

The hollow frame 42 carries a rotatable exhaust fan 46 including a plurality of blades configured to draw gases out from kitchen area 26 through passageway 44 and out the outlet 40 along the exhaust path. Fan 46 may be powered by an electrical motor (not shown) as one having ordinary skill in the art would understand. Exhaust fan 46 rotates about an axis of rotation (i.e. a fan axis of rotation) that is parallel to the roof 16. The fan's axis of rotation is also below the roof 16. This is in contradistinction to currently known devices which mount a fan atop the truck roof (i.e, above the roof) and the fan's axis of rotation is perpendicular to the roof. Stated otherwise, the fan's axis of rotation may substantially perpendicular to one of (i) the left sidewall 20, (ii) the right sidewall 22, and (iii) the rear endwall 66. Stated otherwise, the fan's axis of rotation may parallel to the floor of the kitchen area 26 that supports the cooking devices.

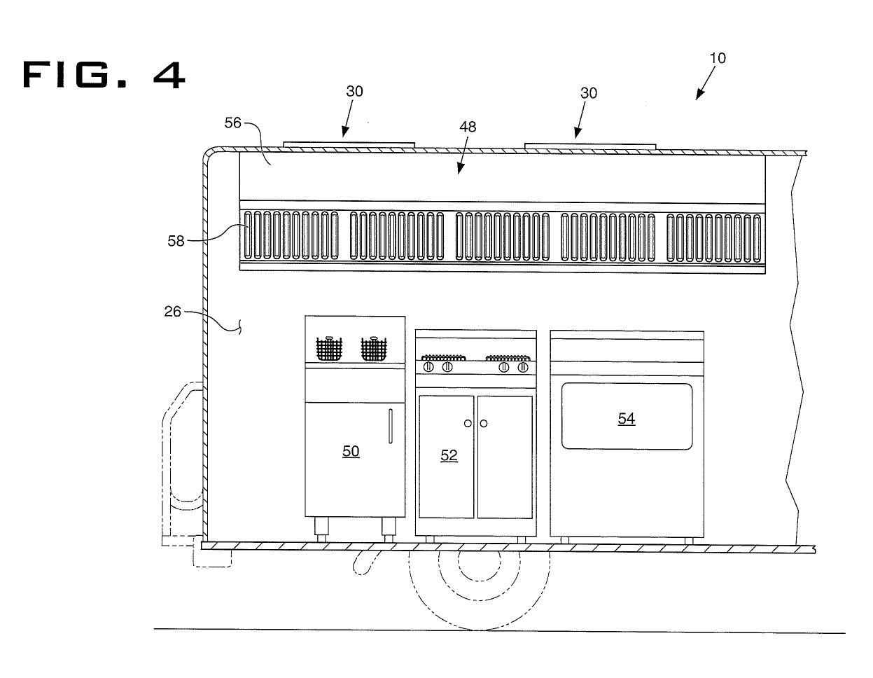

As depicted in FIG. 3 and FIG. 4, exhaust system 30 may further include an exhaust hood 48 inside the kitchen area 26 of the truck 10 and positioned generally vertically above various cooking devices inside the truck 10 that produce cooking gases and suspended fluids that need to be vented such as a deep fryer 50, a stove or grill 52, or an oven 54. The exhaust hood 48 extends generally from the front end of the kitchen area 26 to the rear end of the kitchen area 26 and includes a downwardly extending hood wall 56 connected to roof 16 and an angled and slotted intake member 58 covering an inlet 60 and permitting gasses to move through the inlet 60. The exhaust hood 48 may be rigidly secured to frame 42 creating a rigidly secured relationship between first vent stack 32 and hood 48.

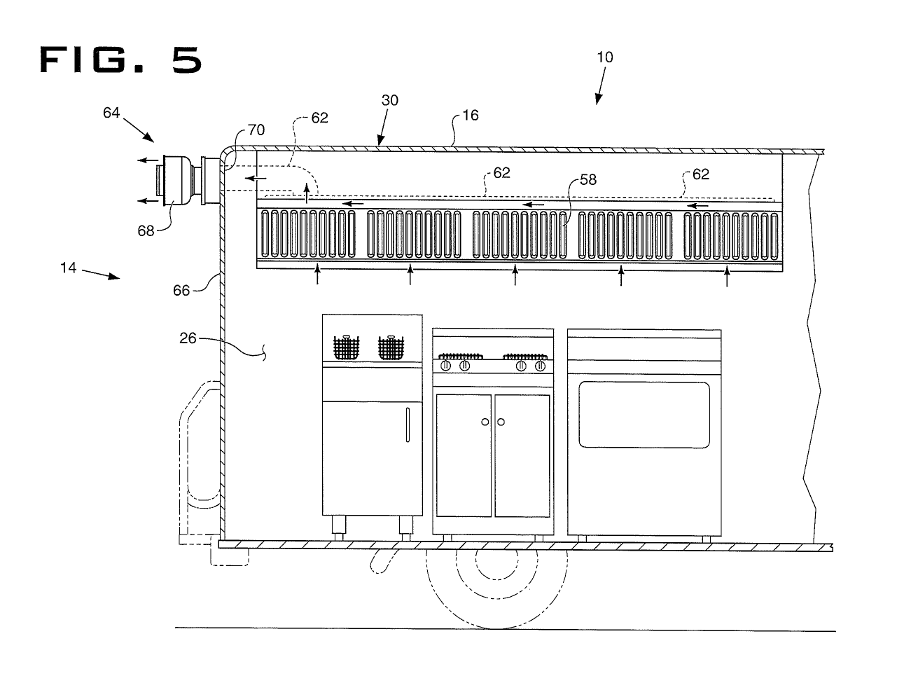

As depicted in FIG. 5, another exemplary embodiment of exhaust system 30 is provided in accordance with this disclosure. In the embodiment depicted in FIG. 5, the exhaust hood 48 is positioned within the kitchen area 26 in a manner similar to that disclosed in FIG. 1 through FIG. 4. However, duct work 62 leads exhaust gases out through a rear facing vent stack 64 mounted to a vertically extending rear panel 66 (also referred to as a rear endwall) defining the rear end 14 of truck 10. The rear facing vent stack 64 may include a fan unit 68 electrically powered to create an air current drawing gases out from the kitchen area 26 to the outside and exterior to the truck. Rear facing vent stack 64 is oriented in a manner such that it does not extend to a height vertically above roof 16. This is advantageous inasmuch as prior art food trucks have exhaust stacks extending upwardly from their roofs which can create hazards when driving on the roads due to height restrictions on certain vehicles. Additionally, there may be two rear facing vent stacks, similar to other embodiments contained herein which depict dual exhaust runs (see generally FIG. 1).

With continued reference to FIG. 5, duct work 62 extends through a rear opening 70 formed in rear panel 66. Opening 70 is entirely below roof 16 and extends longitudinally through rear panel 66. In general, the duct work 62 is substantially located above the cooking devices, such as the deep fryer 50, the stove or grill 52, or the oven 54.

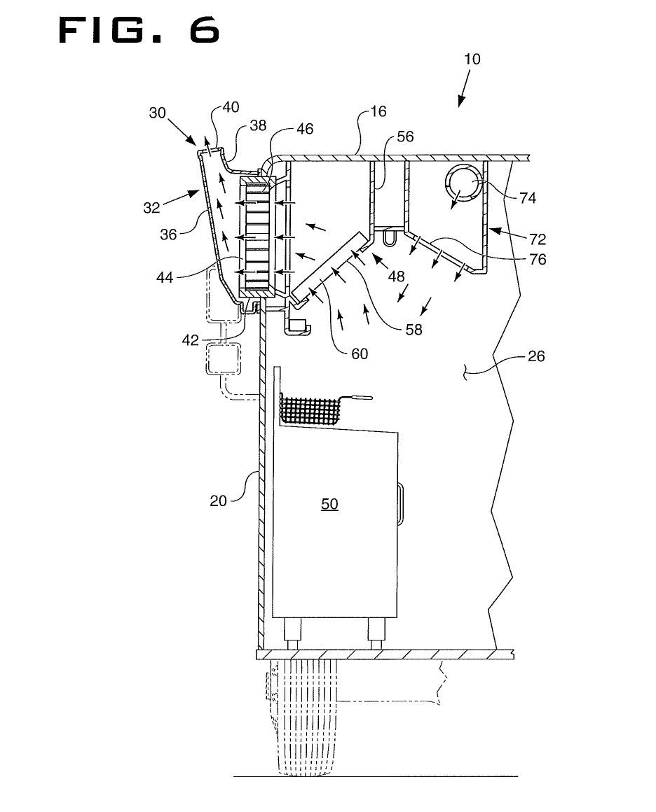

As depicted in FIG. 6, another embodiment that may be incorporated with exhaust hood 48 is an intake hood 72 operatively coupled with an inlet aperture 74 used to draw fresh air inwards through intake hood 72 into kitchen area 26. The intake hood 72 may have an angled outlet 76 inclined in a manner complimentary to that of slotted intake member 58. The inlet aperture 74 is shown as being formed in a front wall of the truck 10, however inlet aperture may be formed in other locations such as through either the left side panel 20, the right side panel 22, the rear panel 66, or the roof 16, or other locations as well.

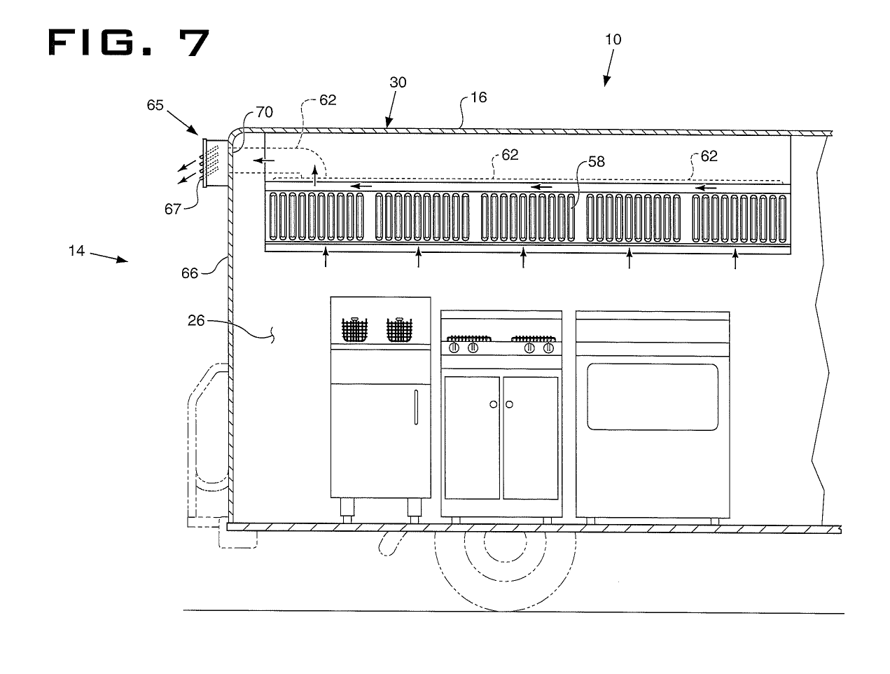

As depicted in FIG. 7, another embodiment of the exhaust system 30 includes a vent discharge 65 having a gravity louvered shutter 67. The vent discharge 65 is shown as exiting rear wall 66 of truck 10 operatively coupled to exhaust ventilation ductwork 62 through hole 70. However, it is to be entirely understood that the vent duct 65 having a gravity louvered shutter 67 may be incorporated into the embodiment of the present disclosure depicted in the other figures, such that the vent discharge 65 having gravity louvered shutters 67 extends through either the right sidewall 22 or left sidewall 20 of truck 10.

With continued reference to FIG. 7, the vent discharge 65 is considered to be a low profile exhaust system outlet relative to the rear end of truck 10 inasmuch as it extends shortly there beyond and is still generally at the same height as the roof 16. In this regard, there may be some instances where a vent discharge 65 may be placed on the roof 16 and extends therethrough so as to provide a top outlet vent for exhaust system 30 that does not add significant height to truck 10. The term “significant height” as used herein refers to anything greater than about ten or twelve inches. In the instance where it may be possible to have vent discharge 65 exiting through the roof 16, the discharge vent will be more similar to that of vent 32 having fixed sidewalls rather than a gravity louvered shutter.

The gravity louvered shutters 67 operate in a manner that move between a closed position sealing duct work 62 and an open position which permits the escapement of exhaust gases therethrough. When a fan is actuated to an on position to draw exhaust fumes outwardly from the kitchen area 26, the shutters 67 move from the closed position to the open position under the force of the moving air. Alternatively, there may be some instances where the shutters are not operated under gravitational forces including mechanical biasing means.

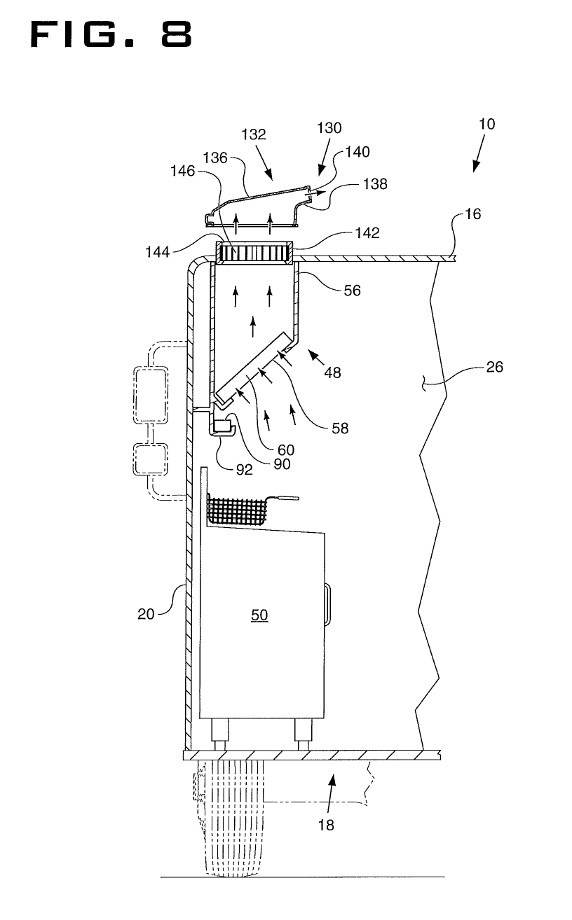

As depicted in FIG. 8, an alternative embodiment of an exhaust system is generally depicted at 130. Alternative exhaust system 130 includes a frame 142 aligned through a hole in roof 16 defining an upwardly extending air passageway 144 in which a vertically aligned fan 146 resides.

With continued reference to FIG. 8, a vent stack 132 is shown in a semi-exploded view above roof 16 for descriptive purposes only. However, it is to be clearly understood that vent stack 132 is mounted onto roof 16. Vent 132 includes an upper wall 136 and a second wall 138 that therebetween define an outlet 140. Second wall 138 is an L-shaped wall similar to that of upper wall 38 in the first embodiment depicted in FIG. 3 but arranged in a manner that allows discharged air to exit through opening 140 in the manner depicted in FIG. 8. While the discharge air is shown as exiting to the right, it is clearly understood that vent 132 may be arranged such that opening 140 face towards the left. Vent 132 is different from conventional exhaust fans that require the fan unit to be mounted above the roof. Here, fan 146 is integrated into roof 16 creating a lower vertical profile height for system 10.

With continued reference to FIG. 8, a grease trap flange 92 may extend downwardly below inlet 60 and retain a removable catch trap 90 therein. This feature may be incorporated into any of the designs shown herein.

In accordance with one aspect and one non-limiting advantage of this disclosure, the exhaust system 30 mounted on food truck 10 provides a low profile system that allows cooking gases to vent outward from the kitchen area outside and exterior to the truck through a vent stack that is not on top of the roof 16. In one particular embodiment, first vent stack 32 is positioned offset to the left side of the left panel 20 and an outlet 40 is either below the roof 16 or just slightly through the roof 16 such as to not add much height to the overall height of truck 10 (i.e, an insignificant amount of height less than about five or ten or twelve inches). This advantage should be readily apparent inasmuch as food trucks have various height restrictions and transportation safety requirements in order to move safely on public roadways.

Another advantage which is readily apparent by aspects of the present disclosure is that by having an embodiment of exhaust system 30 that does not extend above the roof 16 of the truck (and extends through either the left side panel 20, the right side panel 22, or the rear panel 66), the manufacturer of truck 10 is able to construct a truck having a kitchen area 26 with a greater vertical height than conventionally known food trucks. For example, the height of truck 10 may be increased to a height that is ordinarily similar to that of a conventional food truck having an exhaust stack mounted on the roof. This feature allows for more interior cargo and cabin room, the advantage of which is readily apparent.

During fabrication, the manufacturer installs exhaust system 30 onto food truck 10 by mounting first and second vent stacks 32, 34 to either one of the left or right side panels of truck 10. Additionally, while it is depicted herein that the exhaust system 30 includes first vent stack 32 and second vent stack 34, it is entirely possible that more than two vent stacks may be utilized on truck 10. Alternatively, a single vent stack may only be used such as the embodiment depicted in FIG. 5. During fabrication and installation of exhaust system 30, the manufacturer ensures the low profile nature of exhaust system 30 such that the vent stacks 32, 34 do not extend far beyond the top of roof 16. In one particular embodiment, the top outlet 40 on the vent stacks 32, 34 is generally flush with roof 16. Alternatively, the outlet of the vent stacks may be entirely below the roof 16.

In operation and with reference to FIG. 3, a person working in kitchen 26 may turn on one of the cooking devices, such as the deep fryer 50, the stove or grille 52, or the oven 54. Then, food is prepared (i.e, the step of preparing a food item with a cooking device inside a kitchen area in the food truck produced by a cooking device is accomplished) from the kitchen area in the food truck produced by the cooking device. These cooking devices need ventilation and require exhaust system 30 to be initiated during food preparation. An actuation switch may be operatively coupled to the electronic motor powering fan 46 carried by frame 42 disposed within opening/passageway 44 extending transversely through one of the upwardly extending sidewalls of truck 10 below roof 16. As fan 46 begins to rotate, the blades are positioned in a manner to encourage the drawing of air outward from kitchen area 26 through passageway 44. With the fan rotating about an axis parallel to the roof 16 to create negative pressure to draw air outward from the kitchen area 26 above the cooking devices, the cooking exhaust passes through the slotted member 58 carried by hood 48. The cooking exhaust therein flows through passageway 44 and then upwardly through vent stack 32 outwardly through outlet 40. The flow of exhaust gases along the exhaust path is represented by the flowing arrows in FIG. 3.

In operation and with reference to FIG. 6, an alternative embodiment of the present disclosure provides an inlet aperture 74 through which outside fresh air may be drawn inward into the kitchen area 26 through the intake hood 72. The outside air mixes with the cooking exhaust within kitchen 26 and then the mixture is then drawn outward through the vent stack 32 in a manner similar to that described above with reference to FIG. 3.

In operation and with reference to FIG. 5, once the fans are initiated to draw the cooking exhaust outward, duct work 62 may lead the cooking exhaust outward the rear side of truck 10 via vent stack 64.

In each of the embodiments described above, the vent stacks 32, 34 are generally at the same vertical height or lower than roof 16 on truck 10, however they could slightly above the roof such as to only add an insignificant amount of overall height to the vehicle.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A food truck comprising:
a left sidewall spaced from a right sidewall;
a rear endwall extending between the left and right sidewalls;
a roof;
a kitchen area interior to the food truck defined between the left and right sidewalls and below the roof, and within the kitchen area is positioned at least one of the following cooking devices: a deep fryer, an oven, a stove, and a grill; and
a low profile cooking exhaust system defining an exhaust passageway extending at a height generally not exceeding the roof through one of (i) the left sidewall, (ii) the right sidewall, and (iii) the rear endwall adapted to remove resultant cooking gases and fumes from the kitchen area produced by the cooking devices.

2. The food truck of claim 1, further comprising an outlet of the exhaust passageway exterior to one of (i) the left sidewall, (ii) the right sidewall, and (iii) the rear endwall, and the outlet positioned at a height generally similar to that of the roof.

3. The food truck of claim 2, wherein the outlet of the exhaust passageway is defined at a height flush with the roof.

4. The food truck of claim 2, wherein the outlet of the exhaust passageway is defined at a height below the roof.

5. The food truck of claim 2, wherein the outlet of the exhaust passageway is defined by an exterior assembly such that the outlet is positioned transversely offset from one of (i) the left sidewall, (ii) the right sidewall, and (iii) the rear endwall.

6. The food truck of claim 2, wherein the outlet of the exhaust passageway is defined by an exterior assembly such that the outlet is positioned transversely offset from the roof.

7. The food truck of claim 1, further comprising a perpendicular alignment of the exhaust passageway through the one of (i) the left sidewall, (ii) the right sidewall, and (iii) the rear endwall such that the resultant cooking gases and fumes move in a generally transverse direction inside the kitchen area and in a generally vertical direction exterior to the truck.

8. The food truck of claim 1, wherein the exhaust system includes:
a fan positioned along the exhaust passageway, wherein the a portion of fan is below the roof.

9. The food truck of claim 8, further comprising a fan axis of rotation parallel to and below the roof.

10. The food truck of claim 8, further comprising a fan axis of rotation substantially perpendicular to one of (i) the left sidewall, (ii) the right sidewall, and (iii) the rear endwall.

11. The food truck of claim 8, further comprising:
a floor supporting the cooking devices; and
a fan axis of rotation parallel to and above the floor.

12. The food truck of claim 8, further comprising:
a frame carrying the fan, wherein the frame positions the fan in an opening defined by one of (i) the left sidewall, (ii) the right sidewall, and (iii) the rear endwall, wherein the opening is along a portion of the exhaust passageway.

13. The food truck of claim 8, wherein the exhaust system includes:
a first vent stack exterior to the truck extending upwardly and terminating at a height similar to that of a roof.

14. The food truck of claim 13, further comprising a second vent stack exterior to the truck extending upwardly and terminating at a height similar to that of a roof.

15. The food truck of claim 13, wherein the first and second vent stacks are positioned on the same side of the truck.

16. The food truck of claim 8, wherein the exhaust system includes:
a louvered shutter substantially exterior the one of (i) the left sidewall, (ii) the right sidewall, and (iii) the rear endwall and terminating at a height similar to that of the roof.

17. A method comprising:
providing a food truck having a low profile cooking exhaust system defining an exhaust passageway extending at a height generally not exceeding a roof through one of (i) a left sidewall, (ii) a right sidewall, and (iii) a rear endwall;
preparing a food item with a cooking device inside a kitchen area in the food truck produced by a cooking device; and
effecting air movement below the roof along the exhaust passageway through one of (i) the left sidewall, (ii) the right sidewall, and (iii) the rear endwall to remove resultant cooking gases and fumes from the kitchen area in the food truck produced by the cooking device.

18. A food truck comprising:
an engine operatively connected to ground-engaging wheels adapted to transport the food truck;
a longitudinally and vertically extending left sidewall;
a longitudinally and vertically extending right sidewall spaced offset from the left sidewall;
a transversely and vertically extending rear endwall positioned between the left and right sidewalls;
a roof topping the left and right sidewalls and the rear endwall;
a floor extending between the left and right sidewalls;
a kitchen interior to the left and right sidewalls, the rear endwall, and below the roof and above the floor;
a cooking device supported by the floor and disposed in the kitchen requiring adequate ventilation during operation;
a low profile exhaust system including:
at least one vent stack exterior to one of one of (i) the left sidewall, (ii) the right sidewall, and (iii) the rear endwall;
a fan rotatable about an axis parallel to the floor;
an outlet to an exhaust passageway defined by the at least one vent stack, wherein the outlet is at a height proximate the roof.
